(19) United States
(12) Patent Application Publication
(10) Pub. No.: US 2023/0185296 A1
(43) Pub. Date: Jun. 15, 2023

(54) Method for monitoring by means of machine learning

(71) Applicant: Balluff GmbH, Neuhausen a.d.F. (DE)

(72) Inventors: Steffen Gerstenberg, Esslingen (DE); Florian Liebgott, Stuttgart (DE); Albert Dorneich, Ostfildern (DE)

(21) Appl. No.: 18/078,358

(22) Filed: Dec. 9, 2022

(30) Foreign Application Priority Data
Dec. 15, 2021 (DE) 102021133338.5

(51) Int. Cl. G05B 23/02

(52) U.S. Cl. CPC G05B 23/0283; G05B 23/0254

(57) ABSTRACT

A method for monitoring an IO link system and/or at least one IO link device of the IO link system and/or a plant, a plant part and/or a process that works together with the IO link system is suggested. The current (Iₘ), the voltage (Uₘ) and/or the electrical power (Pₘ) are here recorded (42) at at least one port of an IO link master of the IO link system. A monitoring of a condition (Z) and/or a detection of anomalies, errors, deviations and/or maintenance indicators and/or a prediction of a maintenance requirement, an error and/or an outage of the IO link system and/or of the at least one IO link device and/or of the plant, of the plant part and/or of the process in the IO link master occurs by means of a model (M) for the current, the voltage and/or the electrical power previously learned via machine learning.

The present invention relates to the monitoring of IO link systems and/or components that work with the latter by means of machine learning.

### PRIOR ART

In plant construction and in automation technology, numerous normalised fieldbus systems have proved themselves as alternatives to parallel individual wiring. A plurality of so-called fieldbus modules is here attached to a central control device by means of a fieldbus. End devices are attached to the fieldbus modules in turn.

So-called IO link connections have also recently been used to connect the end devices to the fieldbus modules. An IO link connection of this kind, and a method and a control device for operating a connection of this kind, are known from DE 10 2012 009 494 A1. As described there, the fieldbus modules take on the role of an IO link “master”. Sensors, actuators, display devices, operating devices and even drivetrains of machines are considered as end devices (referred to as IO link device in the following).

A consortium of affected producers has specified a standard for an intelligent sensor/actuator interface having the named denotation “IO link”, which is standardised as an international open standard in standard IEC 61131-9. Named IO link devices are then described via description files IODD, IO link device description. IODD should also be standardised as a description language in standard ISO 15745 as an open standard.

An IO link connection of this kind provides a serial point-to-point connection for signal transfer between sensors and actuators and the IO plane of the machine. In principle, an IO link connection transfers data between the IO link master and an IO link device connected as a device.

In order to ensure that a plant or a process functions faultlessly, condition monitoring is carried out, which serves to know the state of a plant or of a process at any time, and to react promptly to deviation. Disturbances can thus be recognised early, and a possible machine stoppage can be prevented. Maintenance work can also be planned in advance, and orientated to the condition of the plant. The condition monitoring thus leads to an efficient, secure and undisturbed operation of the plant, such that the collective efficacity of the plant can be increased.

Typically, only sensor data is used for a condition monitoring. In the simplest case, it is monitored whether defined threshold values are exceeded or fallen short of. A condition monitoring of this kind is sometimes already provided by a sensor.

However, this simple case of threshold value monitoring is not suitable for detecting all conditions, anomalies, errors, deviations and/or maintenance indicators.

A condition monitoring based on artificial intelligence (AI) that is based on machine learning offers a further starting point. In the process, learning occurs on the basis of the plant data and the associated conditions of the often-complex connection between the sensor data and the condition of the plants. An AI-based condition monitoring of this kind has so far only been carried out in the industrial field on edge devices, internal company servers or in the cloud. In these cases, an edge gateway that calls up the sensor data from the fieldbus and provides it for evaluation is respectively required.

If only additional sensors that are not required for controlling the plant are used for the condition monitoring, then these sensors can be directly connected to an evaluation unit. The complexity and the costs of the monitoring system increase due to the additional sensors, however. If sensors that can also be used for controlling the plant are used for the condition monitoring, a connection to the fieldbus is necessary. The condition monitoring on edge devices, servers or in the cloud thus causes additional hardware and wiring effort.

The object of the invention is therefore to provide an AI-based monitoring directly via the IO link system and its components that uses data that is suitable for monitoring and that is accessible for the IO link system or its components.

### DISCLOSURE OF THE INVENTION

A method for monitoring an IO link system and/or at least one IO link device of the IO link system and/or a plant, a plant part and/or a process that works together with the IO link system is disclosed.

According to the invention, the electrical current, the electrical voltage and/or the electrical power are recorded at at least one port of an IO link master of the IO link system. The recording of the electrical variables at the at least one port of the IO link master, in particular in the form of a measurement of the current, of the voltage and/or of the electrical power occurs directly in the IO link master. The current consumption, the voltage and/or the power consumption of the attached IO link devices is thus measured directly in the IO link master.

No additional external sensors are required for the measurement of the electrical variables. The current can be determined in the IO link master in a known manner, for example via the voltage drop at a small resistance (sense or shunt resistance) and transformation of the voltage drop into a digital value. Alternatively, electronic current measurement components can be used, which determine the current from a magnetic field measurement. The voltage can be determined directly via analogue/digital transformation in a known manner. The electronic power P can be calculated according to formula 1 as the product of the current I and the voltage U:

$$P = U ⋅ l$$

According to the invention, an artificial intelligence (AI) based on machine learning is used in the IO link master, in order to carry out one or several of the monitoring aspects, which are later described in detail, on that basis. An AI-based monitoring thus occurs directly via the IO link master. A previously learned model is used for the current, the voltage and/or the electrical power during the machine learning. The learning is also described as training. The model characterises the connection of current, voltage and/or electrical power and the conditions, anomalies, errors, deviations and/or maintenance indicators of the IO link system and/or of the at least one IO link device and/or of the plant, of the plant part and/or of the process.

A so-called intelligent condition monitoring can be carried out as a monitoring aspect. An AI-based monitoring of a condition of the IO link system and/or of the at least one IO link device and/or of the plant, of the plant part and/or of the process are carried out by means of the usage of the previously learned model via the machine learning. The condition is classified via the model for this purpose. Specifically, the condition of the attached IO link device can be monitored via the current consumption, the voltage and/or the electrical power consumption at the at least one IO link port, and its usage can also be optimised. The condition of the plant, of the plant parts and/or of the processes can also be monitored via the named electrical variables at the at least one IO link port, in particular in combination with the sensor data described below. A normal condition can generally be learned here, and deviations from this normal condition can then be recognised. Several conditions are preferably learned in the AI-based condition monitoring, and it is classified in which condition the IO link system and/or the at least one IO link device and/or the plant, the plant part and/or the process is. Unknown conditions can here be recognised as anomalies. The normal condition and/or the several conditions are, for example, also determined in the AI-based condition monitoring via the distribution of the electrical variables named above, via a particular chronological sequence of signal values of the electrical variables, via a periodicity of the signal of the electrical variables and so on. This is not possible with a pure threshold value monitoring. Several models that are active in parallel are generally possible for the purpose of classifying and monitoring the condition.

As a further monitoring aspect, anomalies, errors, deviations and/or maintenance indicators of the IO link system and/or of the at least one IO link device and/or of the plant, of the plant part and/or of the process can be detected. The additional information from the current or power consumption enables the anomalies, errors, deviations and/or maintenance indicators to be reliably recognised. Additional instances of errors or maintenance indicators that cannot be detected from sensor data alone can also be recognised via the current or power data. This applies in particular in the event that the at least one IO link device is an actuator whose condition is monitored neither by the actuator itself nor via sensors.

A further monitoring aspect presents a prediction of a maintenance requirement, an error and/or an outage of the IO link system and/or of the at least one IO link device and/or of the plant, of the plant part and/or of the process. A prediction of this kind is very readily possible with machine learning and a suitable model.

Purely in principle, all current, voltage or electrical power data of the IO link port are suitable for the AI-based monitoring for which there is a connection between the behaviour of the current, the voltage or the electrical power and the conditions, anomalies, errors, deviations or maintenance indicators of the IO link system, or of the at least one IO link device, or of the plant, of the plant part or of the process. These connections need not be obviously or intuitively recognisable. Complex connections between several data sources and the conditions, anomalies, errors, deviations or maintenance indicators that cannot be directly recognised by a user can be identified with the assistance of machine learning.

The measurement and the AI-based evaluation consequently occurs directly on the IO link master. A monitoring of the IO link system, of the IO link devices, of the plant, of the plant parts and/or of the processes thus occurs that could previously not be implemented, or only via additional hardware effort, and this without requiring additional hardware such as sensors. Particular conditions, anomalies, errors, deviations and/or maintenance indicators of the IO link system and/or of the at least one IO link device and/or of the plant, of the plant part and/or of the process can be better monitored, detected and/or predicted, and other conditions, anomalies, errors, deviations and/or maintenance indicators are able to be monitored, detected and/or predicted at all with the AI-based monitoring according to the invention in comparison with conventional setpoint monitoring. An IO link master that uses this method according to the invention thus represents a more comprehensive tool for monitoring in relation to a conventional IO link master.

There are generally several options for the IO link master to learn the model. The model is preferably learned directly in the IO link master. For this purpose, training data is measured for the current, the voltage and/or the electrical power for learning, and the corresponding conditions, anomalies, errors, deviations and/or maintenance indicators are recorded, and from these the model is calculated. The training data can be recorded in advance, wherein the corresponding conditions, anomalies, errors, deviations and/or maintenance indicators are known and caused in particular for training purposes. Alternatively, the training data can also be recorded during learning.

If the model is learned on an IO link master, then it can be provided that the learned model is transferred from this IO link master to at least one other IO link master. This offers the advantage, primarily in the event of other IO link masters being used in an IO link system constructed in the same way that the learning of the model is simplified.

Alternatively, the model can be pre-learned in an external system. The external system can, for example, be an external computer or a cloud. The models can here also be pre-learned in the factory, and already be implemented on the IO link master on delivery, or be transferred to the latter at a later point in time via update.

All available data of the current, of the voltage and/or of the electrical power, or only a partial quantity of the data sources can be used during learning. A pre-processing can also take place during learning and/or during evaluation, in which features can be extracted from the available data, or the data can be transformed, filtered, aggregated and/or otherwise pre-processed. The pre-processing used is connected to the respective model, and implemented together with the latter in the IO link master. The same pre-processing of the data is preferably used when the current, the voltage and/or the electrical power is recorded.

The model can be updated via the measured values while it is being used in operation, said measured values then functioning as training data. The model is thus continuously improved. The model also adapts to changes of the IO link system, of the plant and/or of the process, and remains up to date.

If a particular condition is recognised, then a determined action can be triggered. The recognised condition can be output, for example, and/or an actuator, a plant part and/or a device can be activated or deactivated based on the condition. This can also be carried out in an analogue manner for detected anomalies, errors, deviations and/or maintenance indicators. A warning message can in particular be output in the event of a maintenance requirement, an error and/or an outage being predicted.

It can be provided that the result of the monitoring is output to a user. This can occur in one or several of the following ways, depending on the available components and connections: via a signal on the IO link master (e.g. by means of LEDs, a warning sound or via a display of the IO link master), via a status report via the fieldbus, via the control of an IO link device of the IO link system (e.g. a lighting means, a warning light or a display), via an integrated webserver, via an application in particular for mobile devices, via email, via SMS, via internet service, or via further information channels.

Preferably, a reply can be carried out by the user. An interface, for example as a human machine interface (HMI) can be provided for this purpose, via which the user can undertake an evaluation and/or a correction of the result of the usage of the model, and/or a confirmation or characterisation of the current condition, of the error, of the deviation and/or of the maintenance indicators. The user can thus confirm or correct the result of the monitoring. The monitoring or the model can be improved by means of these replies.

There are different options for recording electrical variables current, voltage and/or electrical power named above. On the one hand, a temporal course of the current, of the voltage and/or of the electrical power can be recorded at a port of the IO link master and used during the monitoring. Particular sequences of signal values of the electrical variables, the periodicity of the signal of the electrical variables etc. can for example be determined from the temporal course, from which the condition can be classified and/or anomalies, errors, deviations and/or maintenance indicators can be detected and/or a prediction of a maintenance requirement, an error and/or an outage can be made. Further variables that are then used in the monitoring can alternatively or additionally be derived from the temporal course.

Furthermore, the current, the voltage and/or the electrical power can be measured at several ports of the IO link master. The measured values combined in particular at a point in time can here be used in the monitoring. It is also possible to record a temporal course of the electrical variables for every port as described above, and to use these variables in combination in the monitoring. Further variables that are then used in combination in the monitoring can alternatively or additionally be derived from the measured values.

Additionally, statistical characteristic values of the electrical variables, such as the mean value, the standard deviation, the variance, the kurtosis, the skewness or the median can be determined and used in the monitoring.

Different classes of algorithms can be used for the machine learning that are known per se. In the following, preferred classes are given as examples:
artificial neural networks;
decision-tree based methods;
margin-based methods;
cluster methods;
ensemble methods;
nearest neighbour methods; and/or
linear and/or non-linear regression methods.

When the condition is classified during the condition monitoring and/or when anomalies, errors, deviations and/or maintenance indicators are detected and/or when a maintenance requirement, an error and/or an outage is predicted, different variants of recognition processes can be used in order to apply the model to the measured values.

A pattern recognition using the measured values for the current, the voltage and/or the electrical power can be provided, in which patterns in the electrical variables and/or in variables derived from them are recognised, and these patterns are connected to the conditions, anomalies, errors, deviations and/or maintenance indicators on the basis of the model. The pattern recognition also allows the prediction of a maintenance requirement, an error, and/or an outage from the patterns. As an example, the patterns can be recognised in the distribution of the electrical variables, in the sequence of signal values of the electrical variables, in the periodicity of the signal of the electrical variables etc.

A statistical test method using the measured values for the current, the voltage and/or the electrical power can alternatively be undertaken when the model is used.

The term “using” should here be understood to mean that the pattern recognition or the statistical test method can be based not only on the measured values, but also on the variables derived from them.

IO link data, and thus data that is directly transferred from one or several of the IO link devices to the IO master, e.g. sensor data, is typically available to the IO link master. This IO link data can additionally be used in the monitoring according to the invention.

On the one hand, the IO link data can already be used when the model is being learned. The learning of the model can also occur independently of the IO link data, however. On the other hand, the IO link data can also be used during the usage of the learned model and/or when a condition is classified and/or when anomalies, errors, deviations and/or maintenance indicators are detected and/or when a maintenance requirement, an error and/or an outage is predicted. The measured electrical variables can here be fused with the IO link data.

Different combinations for monitoring the conditions of different components are shown in the following in exemplary form. These can be transferred to the detection of the anomalies, errors, deviations and/or maintenance indicators and/or to the prediction of the maintenance requirement, of the error and/or of the outage of the respective component:
condition monitoring of an IO link device by means of the electrical variables of an IO link port of the IO link master;
condition monitoring of an IO link device by means of the electrical variables and the received IO link data of an IO link port of the IO link master;
condition monitoring of one or several IO link devices by means of the electrical variables of several IO link ports of the IO master;
condition monitoring of one or several IO link devices by means of the electrical variables and the received IO link data of several IO link ports of the IO link master.
condition monitoring of a plant, of a plant part or of a process by means of the electrical variables of one or several IO link ports of the IO link master;
condition monitoring of a plant, of a plant part or of a process by means of the electrical variables and the received IO link data of one or several IO link ports of the IO link master.

Several of the described variants can here run in parallel on an IO link master. Different models can also be used in parallel for this purpose.

According to the invention, an IO link master is provided with an electronic computing device, e.g., a microcontroller or a microprocessor, that is equipped to carry out the method for monitoring described above.

The solution according to the invention is not limited to IO link devices that are connected to an IO link master. Among others, switching sensors or, for example, also analogue sensors communicating via a signal converter can be connected to an IO link master, and also used for the monitoring. The solution can also be used identically on edge devices having IO link ports or on another device that has the functionality of an IO link master.

It is irrelevant to the invention in connection with what fieldbus system (such as Profibus, Profinet, EtherCAT, CC-Link or Ethernet IP) the IO link master is operated.

### BRIEF DESCRIPTION OF THE DRAWINGS

Exemplary embodiments of the invention are depicted in the drawings and explained in more detail in the following description.

FIG. 1 shows a schematic depiction of an IO link system

FIGS. 2a and 2b respectively show a conventional IO link port according to the state of the art, wherein FIG. 2a shows a 4-pin port, and FIG. 2b shows a 5-pin port.

FIG. 3 is a diagram of a measured current strength over the time for a periodic process of a plant, in which occurring anomalies are marked.

FIG. 4 shows the diagram from FIG. 3, in which detected anomalies are marked via the inventive method.

FIGS. 5a and b show a flowchart of an embodiment of the method according to the invention.

FIG. 6 shows the association between IO link devices and errors, as well as data on the basis of which the errors can be detected.

### EMBODIMENTS OF THE INVENTION

The embodiments for conditions, anomalies, errors, deviations and maintenance indicators are described separately from one another in the following. The described embodiments can transfer to the others and/or be combined with them, however.

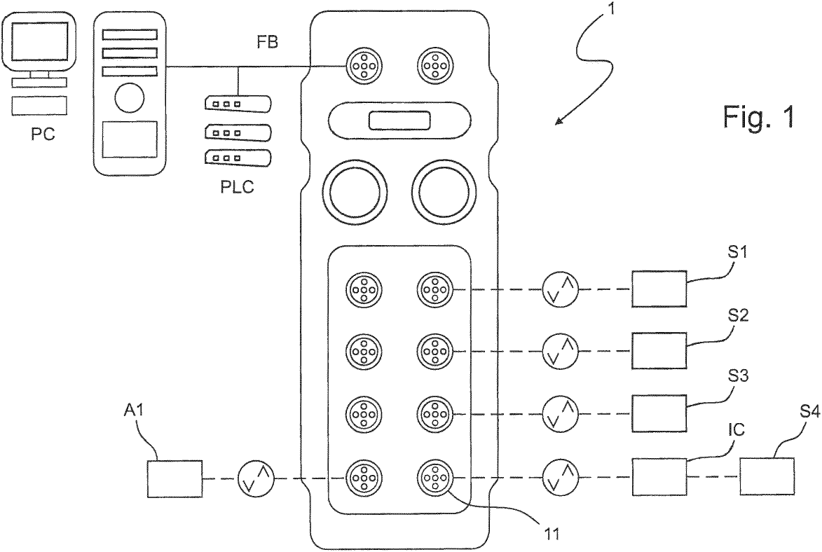

FIG. 1 shows an IO link system having an IO link master 1 that is connected to a programmable control PLC and an external computer PC via a fieldbus FB. The computer PC serves both as external computing device and as interface to a user, via which the result of the monitoring can be output, and the user can give a reply. The IO link master 1 has a computing device (not depicted) that carries out the method according to the invention as described below. The IO link master 1 also has several link ports 11 (only one port is provided with a reference numeral for reasons of overview) that are connected to the IO link devices. Exemplary sensors S1, S2, S3 and S4 - S4 via an inductive coupler IC - and an actuator A1 are each connected to the IO link master 1 via one port 11 each.

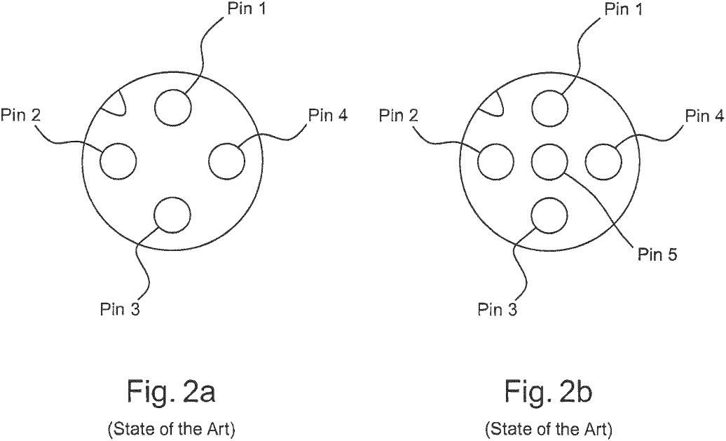

FIG. 2a shows a conventional 4-pin IO link port according to the state of the art, which has four pins in total: pin 1, pin 2, pin 3, pin 4.

FIG. 2b shows a conventional 5-pin IO link port according to the state of the art that has five pins in total: pin 1, pin 2, pin 3, pin 4, pin 5. In the following, the pins are denoted according to the denotation in the connecter, as “pin 1” to “pin 4” or “pin 5”. The IO link port is specified according to the connection technology in IP65/67 in standard IEC 61131-9 in such a way that pin 1 and pin 3 are used to provide energy, and the data is transferred via pin 4. In the IO link port according to type B depicted in FIG. 2b, an additional energy provision is provided via pin 2 and pin 5. In a 4-pin port as shown in FIG. 2a, a current measurement takes place at pin 1 or pin 3, and a voltage measurement is carried out between pin 1 and pin 3. In a 5-pin port as depicted in FIG. 2b, a current measurement can additionally be carried out at pin 2 or pin 5, and a voltage measurement can additionally occur between pin 2 and pin 5.

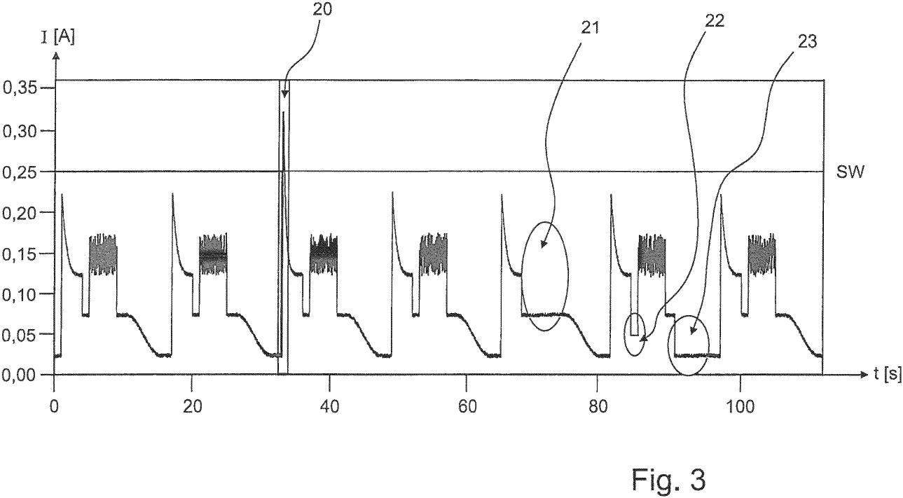

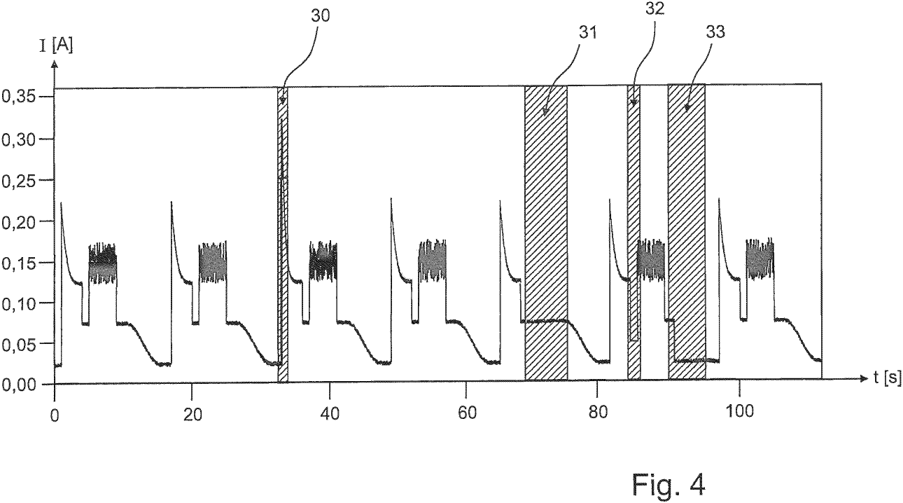

In each of FIGS. 3 and 4, a diagram of a current strength I measured at port 11 of the IO link master 1 over the time t for a periodic process of a plant is depicted. In FIG. 3, anomalies 20 to 23 are marked. While the anomaly 20 manifests as a sharp peak (“outlier”), the anomalies 21, 22 and 23 represent changes in the course. A threshold value monitoring is conventionally carried out, in which the measured current strength I is compared with a threshold value that is here shown as SW for comparison. It can be seen that in this example only the anomaly 20, and thus the “outlier” can be detected in the threshold value monitoring.

Detected anomalies 30 to 33 that have been detected via the method according to the invention are entered in FIG. 4. A comparison with FIG. 3 shows that the detected anomalies 30 to 33 contain both the anomaly 20 in the form of the “outlier” and the anomalies 21, 22 and 23 in the course. All anomalies 20 to 23 can thus be detected via the method according to the invention.

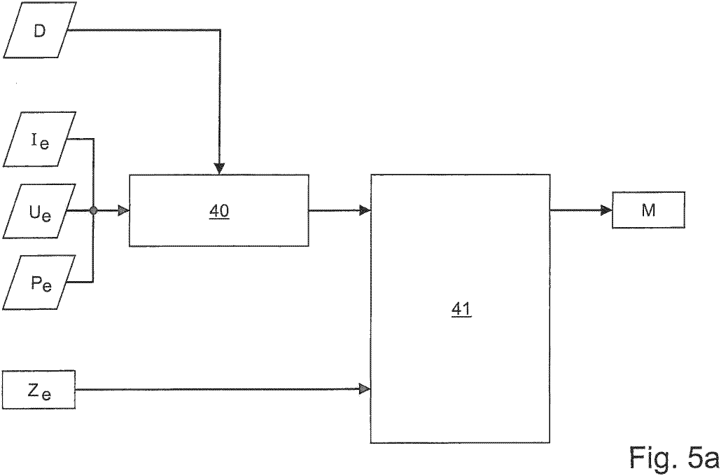

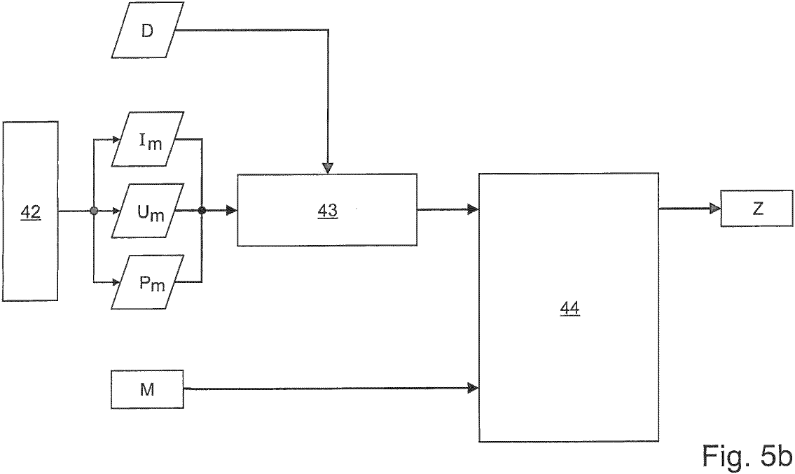

FIGS. 5a and 5b show a flowchart of the method according to the invention for an intelligent condition monitoring. The condition monitoring can be carried out for the entire IO link system, for the IO link devices S1, S2, S3, S4, A1 and/or for a plant, a plant part and/or a process that works together with the IO link system. In the following, the IO link devices S1, S2, S3, S4, A1 should be monitored.

FIG. 5a shows the learning and training phase for a model M. In this exemplary embodiment, the current Iₑ, the voltage Uₑ and/or the electrical power Pₑ are each measured and recorded at the port 11 of the IO link master 1, in order to use these as training data for learning the model. The corresponding conditions Zₑ in which each of the IO link devices S1, S2, S3, S4, A1 are during the measurement are recorded. The training data Iₑ, Uₑ, Pₑ is added to a pre-processing 40. In this exemplary embodiment, IO link data D that is sent over from the sensors S1, S2, S3, S4 to the IO link master 1 is included, and is also added to the pre-processing 40. Features can be extracted from the data or the data can be transformed, filtered, aggregated and/or otherwise processed in the pre-processing 40. The pre-processing 40 used is connected to the particular model M and implemented in the IO link master 1 together with said model. A learning 41 of the model M (also described as training) then occurs, in which the connection between the training data, and thus the current Iₑ, the voltage Uₑ, the electrical power Pₑ and the IO link data D and the corresponding condition Zₑ is learned. The machine learning is based on pattern recognition, for example, in which patterns in the course of the electrical variables Iₑ, Uₑ, Pₑ and the IO link data D are recognised and connected to the conditions Zₑ. This is provided by an artificial neural network, for example, but is not limited to this variant of machine learning. The electrical variables Iₑ, Uₑ, Pₑ and the IO link data D measured for learning can also be maintained during the learning 41 in further exemplary embodiments.

In this exemplary embodiment, the pre-processing 40 and the learning 41 of the model M occurs directly in the computing device of the IO link master 1. The learned models M can be transferred from the IO link master 1 in which they are learned to other IO link masters, which are preferably used in IO link systems constructed in the same manner. In further exemplary embodiments, the learning 41 of the model M occurs on the external computer PC or via a cloud (not depicted), either of which is connected to the IO link master 1 via the fieldbus FB. The model M is finally transferred to the IO link master 1.

FIG. 5b shows the evaluation or operating phase. A measurement 42 of the electrical variables, and thus of the current Iₘ, of the voltage Uₘ and/or the electrical power Pₘ at the ports 11 of the IO link master 1 occurs during operation. The current Iₘ is provided in the IO link master 1 via the voltage drop at a small sense resistance and subsequent transformation of the voltage drop into a digital value. Electronic current measurement components that determine the current Iₘ from a magnetic field measurement can alternatively be used. The voltage Uₘ is determined directly via analogue/digital transformation. The electrical power Pₘ is calculated as the product of the current Iₘ and the voltage Uₘ according to formula 1 (see above). The electrical variables Iₘ, Uₘ, Pₘ measured during operation are added to a pre-processing 43. In this exemplary embodiment, the IO link data D that is sent over from the sensors S1, S2, S3 and S4 to the IO link master 1 is included, and also added to the pre-processing 43. The pre-processing 43 is carried out in the same manner as the pre-processing 40. A classification 44 of the current condition Z then occurs via usage of the model M and the electrical variables measured in operation, and thus the current Iₘ, the voltage Uₘ and the electrical power Pₘ and the IO link data D via machine learning. Here, too, the machine learning is based on pattern recognition, for example, in which patterns are recognised in the course of the measured electrical variables Iₘ, Uₘ, Pₘ and the IO link data D, and the condition Z is classified on the basis of the model M. This is provided by an artificial neural network, for example, but is not limited to this variant of machine learning. Alternatively, a statistical test method is carried out. The model M can be updated during its usage via the measured electrical variables Iₘ, Uₘ, Pₘ and the IO link data D.

Exemplary connections between the condition Z of the IO link device S1, S2, S3, S4, A1 or between a condition of a plant to be monitored and the current or power consumption are described in the following:

In inductive couplers IC, the efficiency of the energy transfer depends on the width of the air gap, the lateral offset and the angular offset of the two couplers and the temperature. Changes in the position of the coupler or the temperature can be recognised via intelligent condition monitoring that includes the current or power consumption of the inductive coupler IC in the monitoring.

In the case of optical distance sensors having adaptive transmission power of the transmission light source (e.g., LED or laser diode), a dirtying of the optical components or a change of the target can be recognised by means of the current or power consumption dependent on the transmission power.

In the case of IO link devices, the current or power consumption of an IO link device can change due to warming or aging (e.g., drying out of electrolyte condensers) of the electronic components. This typically very slow change can also be recognised by means of the intelligent condition monitoring. A prediction of a maintenance requirement can also be made, and an anticipatory maintenance can be planned.

The power consumption of LEDs is fundamentally dependent on the condition of the IO link device (e.g., the display of an alarm condition via a blinking LED). Each LED generates a current consumption of several milliamps only in the lit condition. Defective LEDs of an IO link device can thus be recognised due to deviations between the sensor signal and the current signal.

In sensors for measuring path and spacing (inductive, magnetostrictive, opto-electronic), the current consumption is often connected to the path or spacing in a non-linear manner if the current for energising the sensor element is automatically controlled, in order to compensate for the decay of the measured section, for example. This non-linear dependency can be adopted in the model.

In the case of actuating drives, an insufficient lubrication or corrosion can damage the smoothness of the actuator, which can lead to an increased current or power consumption of the actuating drive. The blockage of a drive is also visible in the course of the current.

In hydraulic or pneumatic plants, a change of the viscosity of the liquid for a magnetic valve can lead, among other things, to a change of the course of the current or the power when switching the valve. If the fluid pressure changes, then this leads to a change of the holding current or of the holding power. Changes of the fluid can thus be recognised without additional sensors.

These examples given above should only be understood as a portion of the various options for intelligent condition monitoring on an IO link master via the usage of the current, of the voltage and/or of the electrical power of the IO link port, and the invention is not limited to these. Far more complex tasks in the area of condition monitoring can also be solved by the method according to the invention, which have a less obvious connection between data and condition.

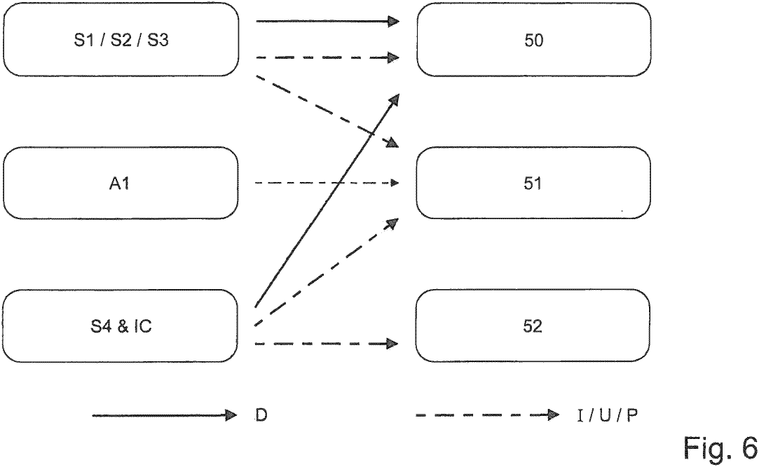

In FIG. 6, the IO link devices S1, S2, S3, A1, S4 & IC from FIG. 1 are listed, and are assigned in exemplary form to different errors (error cases) 50 to 52 by means of the different data types - the IO link data D or the current I, voltage U and/or electrical power P measured at the port 11. The error 50 can be directly detected from the IO link data D. The detection can also occur, however, via the current I, the voltage U and/or the electrical power P by means of the method according to the invention. A combination of the IO link data D and the data of the current I, of the voltage and/or of the electrical power leads to an improvement of the detection. The errors 51 and 52 cannot be detected via the IO link data. They can only be detected by means of the method according to the invention, via the current I, the voltage U and/or the electrical power P. The current I, the voltage U and/or the electrical power P are measured at several ports 11 of the IO link master 1 in order to detect the error 51, such that the data of the current I, the voltage U and/or the electrical current P of one or several of the sensors S1, S2, S3, of the actuator A1 and of the sensor S4 flows in together with the inductive coupler IC when the error 51 is detected. The error 52, however, is detected only from the data of the current I, of the voltage U and/or of the electrical power P of the sensor S4 together with the inductive coupler IC.

1. Method for monitoring an IO link system and/or at least one IO link device (S1, S2, S3, S4, A1) of the IO link system and/or a plant, a plant part and/or a process that works together with the IO link system, the method comprising:
recoding a the current (Iₘ), the-voltage (Uₘ) and/or the electrical power (Pₘ) at at least one port (11) of an IO link master (1) of the IO link system, and
monitoring of a condition (Z) and/or a detection of anomalies (30-33), errors (50-52), deviations and/or maintenance indicators and/or a prediction of a maintenance requirement, an error and/or an outage of the IO link system and/or of the at least one IO link device (S1, S2, S3, S4, A1) and/or of the plant, of the plant part and/or of the process occurs in the IO link master (1) by means of usage of a model (M) for the current (Iₑ), the voltage (Uₑ) and/or the electrical power (Pₑ) previously learned via machine learning.

2. The method according to claim 1, wherein the model (M) is learned in the IO link master (1) via training data being recorded for the current (Iₑ), the voltage (Uₑ) and/or the electrical power (Pₑ) and the corresponding conditions (Z), anomalies (30-33), errors (50-52), deviations and/or maintenance indicators, and the model (M) being calculated from these.

3. The method according to claim 2, wherein the model (M) learned in the link master (1) is transferred to at least one other IO link master.

4. The method according to claim 1, wherein the model (M) is pre-learned in an external system (PC) and transferred to the IO link master (1).

5. The method according to claim 1, wherein the model (M) is updated via the measured values (Iₘ, Uₘ, Pₘ) while being used.

6. The method according to claim 1, wherein an evaluation and/or correction of the result of the usage of the model (M) and/or a confirmation or characterisation of the current condition (Z), anomaly (30-33), error (50-52), deviation and/or maintenance indicator can be undertaken by a user via an interface.

7. The method according to claim 1, wherein a temporal course of the current (Iₘ), of the voltage (Uₘ) and/or of the electrical power (Pₘ) are recorded, and the temporal course and/or variables derived from the latter are used in the monitoring.

8. The method according to claim 1, wherein the current (Iₘ), the voltage (Uₘ) and/or the electrical power (Pₘ) are measured at several ports (11) of the IO link master (1), and the values, their temporal course and/or variables derived from them are used in combination in the monitoring.

9. The method according to claim 1, wherein one of the following variants of machine learning is used:
artificial neural networks
decision-tree based methods;
margin-based methods;
cluster methods;
ensemble methods;
nearest neighbour methods;
linear and/or non-linear regression methods.

10. The method according to claim 1, wherein a pattern recognition using the measured values for the current (Iₘ), the voltage (Uₘ) and/or the electrical power (Pₘ) is undertaken on the basis of the model (M) in the event of a classification (44) of a condition (Z) and/or when anomalies (30-33), errors (50-52), deviations and/or maintenance indicators are detected, and/or when a maintenance requirement, an error and/or an outage is predicted.

11. The method according to claim 1, wherein a statistical test method using measured values for the current (Iₘ), the voltage (Uₘ) and/or the electrical power (Pₘ) is undertaken when using the model (M) in the event of a classification (44) of a condition (Z) and/or when anomalies (30-33), errors (50-52), deviations and/or maintenance indicators are detected, and/or when a maintenance requirement, an error and/or an outage is predicted.

12. The method according to claim 1, wherein additional IO link data (D) that is transferred from one or several of the IO link devices (S1, S2, S3, S4, A1) is used during learning (41) of the model (M), and/or in the usage of the learned model (M), and/or in a classification (44) of a condition (Z) and/or when anomalies (30-33), errors (50-52), deviations and/or maintenance indicators are detected, and or when a maintenance requirement, an error and/or an outage are predicted.

13. The method according to claim 1, wherein the monitoring is provided by the IO link master (1) having an electronic computing device that is equipped to carry out the monitoring.
